(19) United States
(12) Patent Application Publication
(10) Pub. No.: US 2004/0139223 A1
(43) Pub. Date: Jul. 15, 2004

(54) Connection services

(76) Inventor: Paul Caplin, London (GB)

Correspondence Address: JONES DAY, 222 EAST 41ST ST, NEW YORK, NY, 10017, US

(21) Appl. No.: 10/475,949

(22) PCT Filed: Apr. 19, 2002
(86) PCT No.: PCT/GB02/01833

(30) Foreign Application Priority Data
Apr. 25, 2001 (EP) 01303766.8

(51) Int. Cl. G06F 15/16

(52) U.S. Cl. 709/237; 709/220

(57) ABSTRACT

A user requiring financial information from a number of different sources connects to a single directory server, or quote portal, which lists the information services available. The user selects the required services and receives a signed applet from the quote portal, which he explicitly accepts to allow the applet to set up connections with each of the servers which provide the requested services. The data from the selected servers is simultaneously displayed within a single browser screen.

### FIELD OF THE INVENTION

This invention relates to the provision of connection services across a communications network, particularly but not exclusively to a directory server and a method of providing information to a browser from a plurality of information servers with the aid of a directory server.

### BACKGROUND

In the general model of a client-server system operating over any private or public network, such as the Internet, a client computer uses a web client, usually referred to as a browser, to connect to one of many available servers. In the case of, for example, real-time financial information, a multiplicity of service providers provide information over the Internet. In general terms, each provider has its own access requirements and uses its own symbology and its own presentation format, so that a subscriber to the information service provided by any particular provider has to set up a specific configuration for that service and often needs to download a provider specific viewer for viewing the service. A user will often require access to a number of information services from different service providers, ideally with the ability to display all of the specified information within a single screen.

### SUMMARY OF THE INVENTION

According to the present invention, there is provided a directory server for enabling a browser to connect to a plurality of information servers, comprising means for providing a program to the browser for execution by the browser, the program being operative to permit the browser to connect to each of the plurality of information servers in order to receive information from the information servers for concurrent display by the browser.

The program can be arranged to accept configuration information from a user, for example the urls of the servers, to permit the browser to connect to each of the plurality of information servers.

Alternatively, the directory server can further comprise means for receiving a request for information from the browser, the request relating to information available from the plurality of information servers, the program including configuration information to permit the browser to connect to each of the plurality of information services in accordance with the information request.

Advantageously, the connection data for all of the information servers is provided at the directory server so that the applet can be pre-configured. The browser can then obtain from a single source all the data necessary to establish multiple connections to a plurality of information servers operated by different service providers, without needing to establish entirely separate transactions with each service provider. Furthermore, payment can be arranged at the directory server, rather than with individual service providers.

According to the present invention, there is also provided a method of providing information to a browser from a plurality of information servers, comprising providing a program to the browser for execution by the browser, the program being operative to permit the browser to connect to each of the plurality of information servers in order to receive information from the information servers for concurrent display by the browser.

The method can including associating verification information with the program to signify that it is a trusted program, including digitally signing the program at the directory server.

The program, such as a Java applet, in its default state, may prevent the browser from establishing connections to the information servers, in which case the method can further comprise requesting permission from the browser to override the default state in respect of the information servers corresponding to the information request.

In response to receiving permission from the browser, the applet can open a connection to each information server for which it is configured, can receive data from the servers and can provide the data for simultaneous display within a single browser screen.

In a further aspect, the present invention provides a directory server for enabling a browser to connect to a plurality of information servers, comprising means for receiving a request for information from the browser, the request relating to information available from the plurality of information servers and means for providing a program to the browser for execution by the browser in response to said request, the program including configuration information to permit the browser to connect to each of the plurality of information servers in accordance with the information request in order to receive information from the information servers for concurrent display by the browser.

There is also provided, according to the invention, a method of providing information to a browser from a plurality of information servers, comprising receiving a request for information from the browser at a directory server, the request relating to information available from the plurality of information servers and in response to said request, providing a program to the browser for execution by the browser, the program including configuration information to permit the browser to connect to each of the plurality of information servers in accordance with the information request in order to receive information from the information servers for concurrent display by the browser.

According to the present invention, there is also provided a computer program for execution by a browser to enable the browser to connect to a plurality of information servers, comprising configuration information to permit the browser to connect to each of a plurality of information servers in accordance with an information request received from the browser at a directory server, the program being arranged such that, when executed by the browser, the program connects to the plurality of information servers in accordance with the information request in order to receive information from the information servers for concurrent display by the browser.

### BRIEF DESCRIPTION OF THE DRAWINGS

Embodiments of the invention will now be described, by way of example, with reference to the accompanying drawings, in which:

FIG. 1 illustrates a conventional connection scheme between a client and multiple servers over a communications network;

FIG. 2 illustrates a connection scheme according to a first aspect of the invention in which a directory server is provided;

FIG. 3 is a schematic diagram of a conventional computer used to connect to a network;

FIG. 4 is a flow diagram illustrating the process of connecting a client to a plurality of information servers using a directory server in accordance with the first aspect of the invention;

FIG. 5 is a schematic diagram illustrating the data flows occurring in the system of FIG. 2;

FIG. 6 illustrates a web page produced by the directory server showing a directory of available information services;

FIG. 7 illustrates a web page displaying real-time financial data from several information sources; and

FIG. 8 is a flow diagram illustrating the process of connecting a client to a plurality of information servers in accordance with a second aspect of the invention.

### DETAILED DESCRIPTION

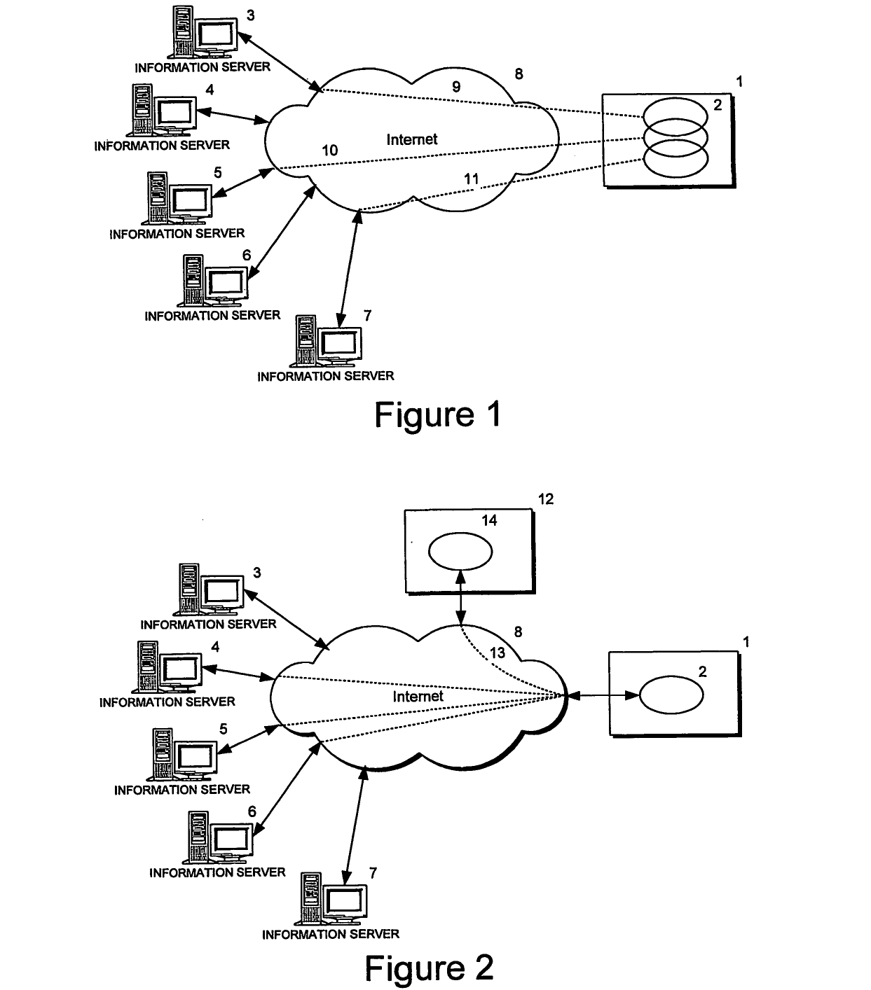

FIG. 1 illustrates a conventional system by which a client computer 1 running multiple instances of browser software 2 obtains financial information from a number of service providers operating separate information servers 3-7 via a public network such as the Internet 8. To obtain the information, the client 1 establishes separate connections 9, 10, 11 from separate browser instances 2 to servers 3, 5, 7 operated by selected providers and downloads the relevant information. As a result, the client needs to obtain a separate subscription to each service provider, data from multiple providers cannot easily be combined on the client display and the formats and symbology used by each of the service providers are likely to be incompatible at the client 1.

FIG. 2 illustrates a connection scheme in accordance with the invention. A directory server 12 is provided separate from the information servers 3-7. When the client 1 wishes to obtain financial information from any of the information servers 3-7, it first establishes a connection 13 to a web server process 14 running on the directory server machine 12, as will be described in more detail below.

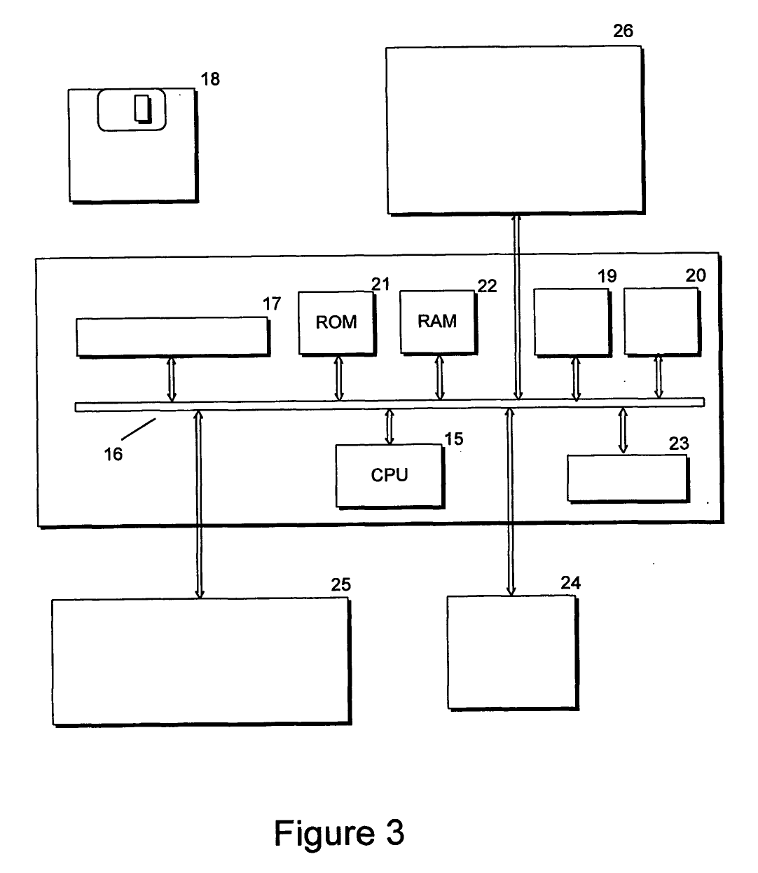

The client, information server and directory server computers 1, 3-7, 12 are conventional computers, an example architecture for which is shown in FIG. 3. Each computer comprises a central processing unit (CPU) 15 for executing computer programs and managing and controlling the operation of the computer. The CPU 15 is connected to a number of devices via a bus 16, the devices including a read/write device 17, for example a floppy disk drive for reading and writing data and computer programs to and from a removable storage medium such as a floppy disk 18, a storage device 19, for example a hard disk drive for storing system and application software, a CD-ROM drive 20 and memory devices including ROM 21 and RAM 22. The computer further includes a network card 23 for interfacing to a network such as the Internet 8 and user input/output devices, such as a mouse 24, keyboard 25 and display 26. It will be understood by the skilled person that the above described architecture is not limiting, but is merely an example of a typical computer architecture. It will be further understood that the described computer has all the necessary operating system and application software to enable it to fulfil its particular purpose, including web server and Java enabled browser software as appropriate.

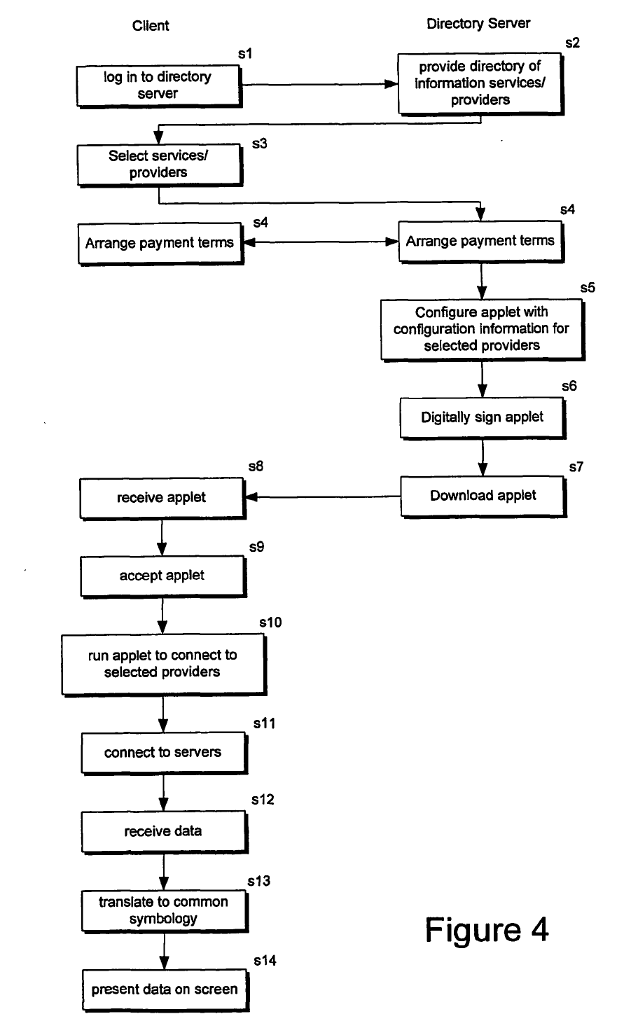

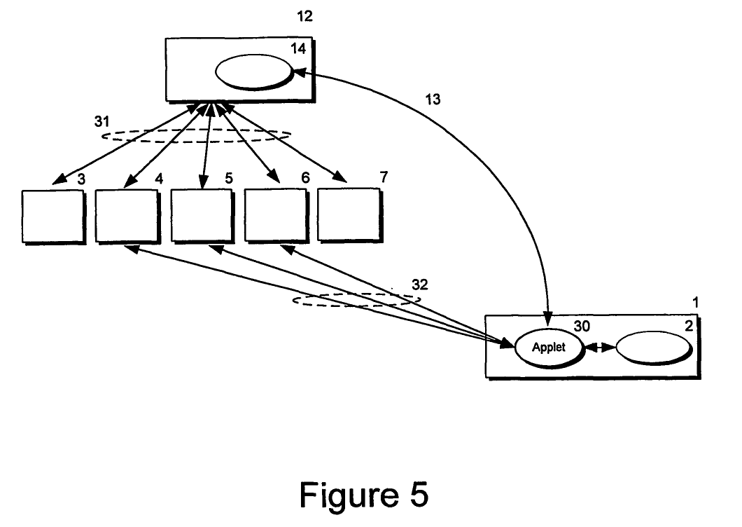

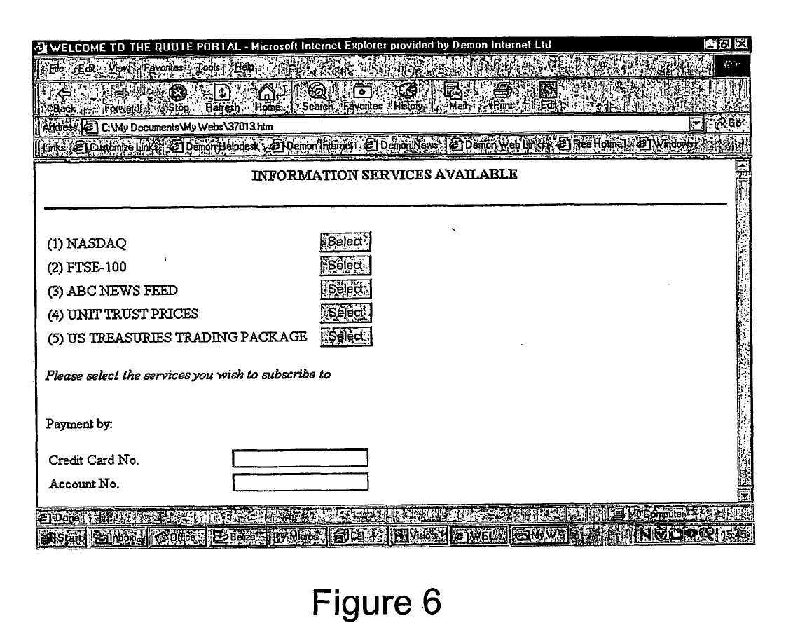

The procedure followed by a user wishing to obtain financial information from any of the servers 3-7 is described below with reference to FIGS. 4, 5 and 6. The servers 3-7 are configured as web servers which are capable of pushing streaming data to a browser. Referring to FIGS. 4 and 5, a user uses the browser software 2, for example Microsoft Internet Explorer™ or Netscape Navigator™, running on the client computer 1, to establish a connection 13 to the directory server (step s). Web server software 14 running on the directory server machine 12 provides a web page having a directory of available information services or information service providers (step s2). An example web page, which is also referred to herein as a quote portal, is shown in FIG. 6. The user selects the information services that he wishes to view (step s3) and payment terms are then arranged between the directory server 12 and the client 1 (step s4). The payment terms can comprise any commercial arrangement, for example a subscription fee payable through a preexisting account arrangement for each information service selected. As well as selecting individual services, a user can be offered a number of trading packages which include a single subscription to all of the servers required for a particular type of trading activity.

Following arrangement of payment, the directory server 12 configures a Java™ applet 30 with all of the information required for the client 1 to log in to the servers providing the selected information services (step s5). This includes the URLs of the selected servers and login information. The configuration information is held by the directory server 12 by virtue of prior agreements 31 made with the service providers which maintain each of the information servers 3-7. The applet can also be configured to translate the symbology of each of the servers so that the symbols provided by each information provider are translated to a common symbol set for viewing by the client browser.

The configured applet 30 is digitally signed by the directory server 12 by means of a digital certificate (step s6) and downloaded to the client 1 (step s7).

The way in which an applet is digitally signed differs between browsers but is well known per se. The purpose of applying the digital signature is to enable the client 1 to override the applet's default behaviour. One of the main tenets of the Java™ language is to enable browsers to run untrusted applets safely. In general terms, all downloaded applets are considered to be untrusted. To prevent an applet from performing operations which could damage the client system on which it runs, an untrusted applet is prevented by the Java Applet Security Manager, which is part of the Java Run-time Environment running on the client's system, from performing a number of tasks on that system, which include writing to the client's local file system and making network connections other than to the originating host. This latter restriction would prevent the downloaded applet 30 from making the necessary network connections to the information servers 3-7.

The Java™ language provides mechanisms for converting untrusted applets to trusted applets. For example, in Java 2™, policy files stored on the client system control the functionality of signed applets. Further details of Java™ security issues can be found at the Java™ website, for example at http://java.sun.com.

Referring again to FIGS. 4 and 5, to enable an applet running at the client 1 to open direct connections 32 to the information servers 3-7, the applet 30 is converted to a trusted applet by the digital signature applied at the directory server 12. After the signed applet 30 is received at the client 1 (step s8) the user explicitly accepts the signed applet (step s9) to enable the system of the invention to operate. On indicating acceptance, the applet is run (step s10) and opens connections 32 to each of the selected servers 4, 5, 6 (step s11). The applet 30 then receives streaming data from each server (step s12), translates the symbology used by each particular server to a common symbology for display (step s13) and presents that data to the browser screen for display (step s14).

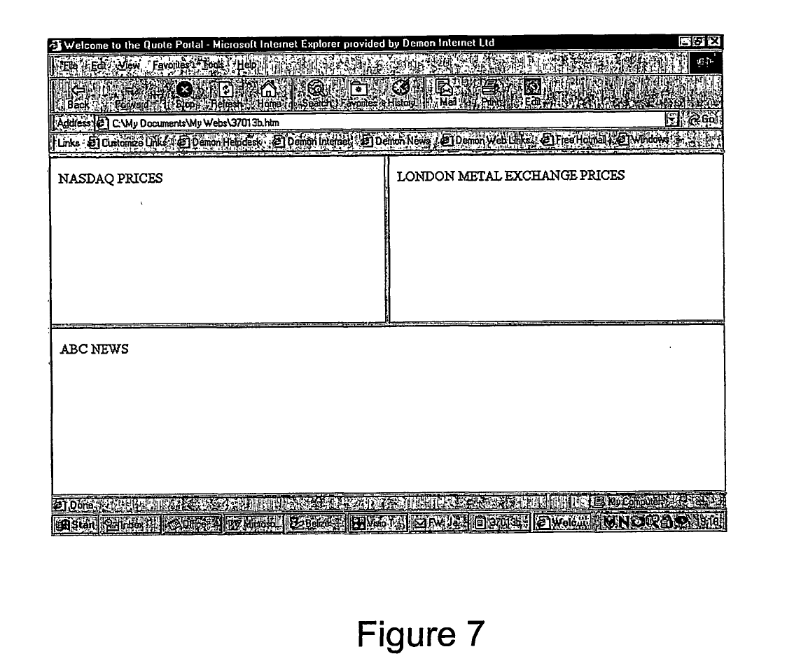

FIG. 7 shows an example browser screen divided into three parts so that data from each of the servers can be simultaneously displayed on different parts of the screen. It is equally possible to combine data from several servers within any one part of the screen, or combine arithmetically data elements from multiple sources to produce derived data for display. The opening of simultaneous connections to each of the data servers is handled by the multithreading capability of the Java™ language.

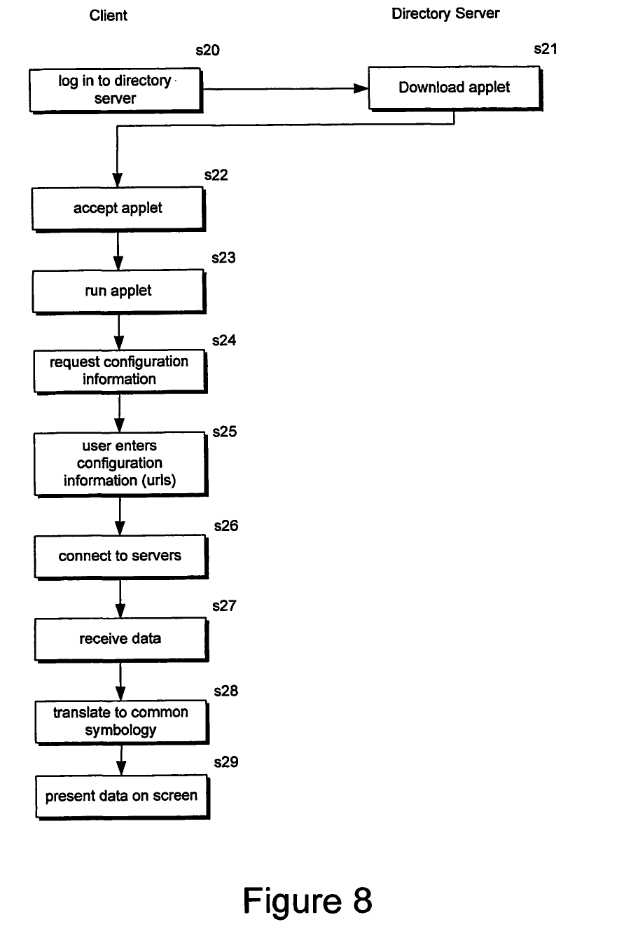

The example above has been primarily described in terms of the directory server providing a directory of information servers and pre-configuring the applet with information to enable the applet to connect to the selected servers. In a further embodiment, the directory server simply provides an applet which is capable of connecting to multiple information servers and capable of accepting configuration information from the user to connect to the required information servers. Referring to FIG. 8, a client uses a browser to connect to the directory server (step s20), from which the client downloads a signed applet (step s21). As in the case of the first embodiment, the user accepts the signed applet (step s22), which then runs on the client machine (step s23) and requests configuration information for the servers to which it is permitted to connect, for example via a dialog box (step s24). The user enters the configuration information, for example, the urls for the required servers (step s25) and the applet then opens connections to the requested servers (step s26). The receipt of data, symbology translation and data presentation proceeds in a similar way to that of the first embodiment (steps s27-s29).

While the embodiments have been described in terms of the use of a Java™ applet, the skilled person will appreciate that the invention can be implemented by the use of any computer language which has similar functionality.

1. A directory server for enabling a browser to connect to a plurality of information servers, comprising:
means for providing a program to the browser for execution by the browser, the program being operative to permit the browser to connect to each of the plurality of information servers in order to receive information from the information servers for concurrent display by the browser.

2. A directory server according to claim 1, wherein the program is arranged to accept configuration information to permit the browser to connect to each of the plurality of information servers.

3. A directory server according to claim 1, further comprising means for receiving a request for information from the browser, the request relating to information available from the plurality of information servers, the program including configuration information to permit the browser to connect to each of the plurality of information services in accordance with the information request.

4. A directory server according to any one of the preceding claims, further comprising means for associating the program with verification information identifying it as a trusted program.

5. A directory server according to claim 4, wherein said associating means comprise means for digitally signing the program.

6. A directory server according to any one of the preceding claims, wherein the program is an applet.

7. A directory server according to claim 6, including a web server for providing a web page which includes the applet.

8. A directory server according to any one of the preceding claims, further comprising means for receiving payment for procuring access to the information servers.

9. A directory server according to any one of the preceding claims, arranged to offer a single trading package covering two or more of the plurality of information servers.

10. A method of providing information to a browser from a plurality of information servers, comprising:
providing a program to the browser for execution by the browser, the program being operative to permit the browser to connect to each of the plurality of information servers in order to receive information from the information servers for concurrent display by the browser.

11. A method according to claim 10, including the step of supplying configuration information to the program to permit the browser to connect to each of the plurality of information servers.

12. A method according to claim 10, further comprising the step of receiving a request for information from the browser, the request relating to information available from the plurality of information servers, and in response to said request configuring the program to permit the browser to connect to each of the plurality of information services in accordance with the information request.

13. A method according to any one of claims 10 to 12, including associating verification information with the program to signify that it is a trusted program.

14. A method according to claim 13, wherein the step of associating verification information comprises digitally signing the program at the directory server.

15. A method according to any one of claims 10 to 14, further comprising downloading the program to a client.

16. A method according to claim 15, wherein the program, in its default state, prevents the browser from connecting to any of the information servers, the method further comprising the step of requesting permission from the client to override the default state in respect of the information servers corresponding to the information request.

17. A method according to claim 16, including verifying that the program is a trusted program.

18. A method according to claim 16 or 17, further comprising, in response to receiving said permission from the client, opening a connection to each of the information servers in accordance with the configuration of the program.

19. A method according to claim 18, further comprising providing means for translating the symbology of any one of the information servers to a common symbology.

20. A method according to any one of claims 10 to 19, wherein the program is an applet.

21. A method according to any one of claims 10 to 20, further comprising providing configuration information for a prepackaged set of information servers in response to a single request.

22. A method according to any one of claims 10 to 21, comprising arranging payment at the directory server for procuring access to the information servers.

23. A directory server for enabling a browser to connect to a plurality of information servers, comprising:
means for receiving a request for information from the browser, the request relating to information available from the plurality of information servers; and
means for providing a program to the browser for execution by the browser in response to said request, the program including configuration information to permit the browser to connect to each of the plurality of information servers in accordance with the information request in order to receive information from the information servers for concurrent display by the browser.

24. A method of providing information to a browser from a plurality of information servers, comprising:
receiving a request for information from the browser at a directory server, the request relating to information available from the plurality of information servers; and
in response to said request, providing a program to the browser for execution by the browser, the program including configuration information to permit the browser to connect to each of the plurality of information servers in accordance with the information request in order to receive information from the information servers for concurrent display by the browser.

25. A computer program for execution by a browser to enable the browser to connect to a plurality of information servers, comprising:
configuration information to permit the browser to connect to each of a plurality of information servers in accordance with an information request received from the browser at a directory server, the program being arranged such that, when executed by the browser, the program connects to the plurality of information servers in accordance with the information request in order to receive information from the information servers for concurrent display by the browser.

26. A computer program according to claim 25 on a carrier medium.
